(19) United States
(12) Patent Application Publication
(10) Pub. No.: US 2024/0287332 A1
(43) Pub. Date: Aug. 29, 2024

(54) Dispersant-Containing Liquid And Aqueous Coloring Material Dispersion Liquid

(71) Applicant: SEIKO EPSON CORPORATION, Tokyo (JP)

(72) Inventor: Hiroshi ITO, Matsumoto (JP)

(21) Appl. No.: 18/588,087

(22) Filed: Feb. 27, 2024

(30) Foreign Application Priority Data
Feb. 28, 2023 (JP) 2023-029318

(51) Int. Cl. C09D 11/322; C09D 11/033; C09D 11/104; C09D 11/107

(52) U.S. Cl. CPC C09D 11/322; C09D 11/033; C09D 11/104; C09D 11/107

(57) ABSTRACT

A dispersant-containing liquid of the present disclosure includes an anionic resin containing a carboxyl group and/or a sulfo group and having an acid value of 50 mgKOH/g or greater and 300 mgKOH/g or less as an anionic functional group, linear monoalkylamine, and water, and the linear monoalkylamine is a compound represented by a predetermined chemical formula.

The present application is based on, and claims priority from JP Application Serial Number 2023-029318, filed Feb. 28, 2023, the disclosure of which is hereby incorporated by reference herein in its entirety.

### BACKGROUND

### 1. Technical Field

The present disclosure relates to a dispersant-containing liquid and an aqueous coloring material dispersion liquid.

### 2. Related Art

A dispersion liquid in which a dispersoid is dispersed in a dispersion medium containing water has been used for various applications.

Examples of such a dispersion liquid include an ink in which a coloring material is dispersed in a dispersion medium containing water.

A dispersant is added to such a dispersion liquid in some cases for the purpose of improving dispersibility of the dispersoid and improving jetting stability using an ink jet method.

A resin type dispersant is particularly advantageous as the dispersant from the viewpoint of having a high affinity for a coloring material, less odor, and the like.

As an ink formed of such a resin type dispersant, for example, an aqueous pigment dispersion liquid prepared by adding an aqueous medium to a kneaded material containing a pigment, an anionic group-containing organic polymer compound as a resin type dispersant, a basic compound such as potassium hydroxide, and polyethylene glycol monooleyl ether is known (see JP-A-2018-002798).

However, in the related art, since the resin type dispersant has low initial wettability with respect to a coloring material, disintegration and dispersion powder of the coloring material for dispersion of the coloring material during preparation of an ink which is a dispersion liquid are insufficient, the dispersion time increases, and thus the stress on the organic coloring material during dispersion increases. Therefore, problems of insufficient dispersion stability of the ink and the like are likely to occur.

### SUMMARY

The present disclosure has been made to solve the above-described problems, and can be realized by the following aspects.

According to an aspect of the present disclosure, there is provided a dispersant-containing liquid including an anionic resin containing a carboxyl group and/or a sulfo group and having an acid value of 50 mgKOH/g or greater and 300 mgKOH/g or less as an anionic functional group, linear monoalkylamine, and water, in which the linear monoalkylamine is at least one selected from the group consisting of a compound represented by Formula (1), a compound represented by Formula (2), a compound represented by Formula (3), a compound represented by Formula (4), and a compound represented by Formula (5),

CH₃(CH₂)ₐ—NH—(CH₂)_{b}—OH (1)
in Formula (1), a represents an integer of 2 or greater and 5 or less, and b represents 2 or 3,

CH₃(CH₂)ₐ—O—(CH₂)_{c}—NH₂ (2)
in Formula (2), a represents an integer of 2 or greater and 5 or less, and c represents an integer of 1 or greater and 3 or less,

CH₃(CH₂)ₐ—(O—CH₂CH₂)₂—NH₂ (3)
in Formula (3), a represents an integer of 2 or greater and 5 or less,

CH₃(CH₂)ₐ—CH(OH)—CH₂—NH₂ (4)
in Formula (4), a represents an integer of 2 or greater and 5 or less,

CH₃(CH₂)ₐ—CH(NH₂)—CH₂—OH (5)
in Formula (5), a represents an integer of 2 or greater and 5 or less.

According to another aspect of the present disclosure, there is provided an aqueous coloring material dispersion liquid including at least one organic coloring material selected from the group consisting of a pigment, a disperse dye, and an oil-soluble dye, an anionic resin containing a carboxyl group and/or a sulfo group and having an acid value of 50 mgKOH/g or greater and 300 mgKOH/g or less as an anionic functional group, linear monoalkylamine, and water, in which the linear monoalkylamine is at least one selected from the group consisting of a compound represented by Formula (1), a compound represented by Formula (2), a compound represented by Formula (3), a compound represented by Formula (4), and a compound represented by Formula (5),

CH₃(CH₂)ₐ—NH—(CH₂)_{b}—OH (1)
in Formula (1), a represents an integer of 2 or greater and 5 or less, and b represents 2 or 3,

CH₃(CH₂)ₐ—O—(CH₂)_{c}—NH₂ (2)
in Formula (2), a represents an integer of 2 or greater and 5 or less, and c represents an integer of 1 or greater and 3 or less,

CH₃(CH₂)ₐ—(O—CH₂CH₂)₂—NH₂ (3)
in Formula (3), a represents an integer of 2 or greater and 5 or less,

CH₃(CH₂)ₐ—CH(OH)—CH₂—NH₂ (4)
in Formula (4), a represents an integer of 2 or greater and 5 or less,

CH₃(CH₂)ₐ—CH(NH₂)—CH₂—OH (5)
in Formula (5), a represents an integer of 2 or greater and 5 or less.

### BRIEF DESCRIPTION OF THE DRAWINGS

FIG. 1 is a table collectively listing conditions of dispersant-containing liquids according to Examples A1 to A8 and Comparative Examples A1 to A6.

FIG. 2 is a table collectively listing conditions of stock solutions of ink jet inks according to Examples B1 to B8 and Comparative Examples B1 to B6.

FIG. 3 is a table collectively listing conditions of ink jet inks according to Examples C1 to C8 and Comparative Examples C1 to C6.

FIG. 4 is a table collectively listing evaluation results of ink jet inks according to Examples C1 to C8 and Comparative Examples C1 to C6.

### DESCRIPTION OF EMBODIMENTS

Hereinafter, preferred embodiments of the present disclosure will be described in detail.

### <1> Dispersant-Containing Liquid

First, a dispersant-containing liquid of the present disclosure will be described.

A dispersant-containing liquid according to the present disclosure contains an anionic resin containing a carboxyl group and/or a sulfo group and having an acid value of 50 mgKOH/g or greater and 300 mgKOH/g or less as an anionic functional group, linear monoalkylamine, and water. Further, the linear monoalkylamine is at least one selected from the group consisting of a compound represented by Formula (1), a compound represented by Formula (2), a compound represented by Formula (3), a compound represented by Formula (4), and a compound represented by Formula (5).

CH₃(CH₂)ₐ—NH—(CH₂)_{b}—OH (1)
(In Formula (1), a represents an integer of 2 or greater and 5 or less, and b represents 2 or 3.)

CH₃(CH₂)ₐ—O—(CH₂)_{c}—NH₂ (2)
(In Formula (2), a represents an integer of 2 or greater and 5 or less, and c represents an integer of 1 or greater and 3 or less.)

CH₃(CH₂)ₐ—(O—CH₂CH₂)₂—NH₂ (3)

In Formula (3), a represents an integer of 2 or greater and 5 or less.)

CH₃(CH₂)ₐ—CH(OH)—CH₂—NH₂ (4)
(In Formula (4), a represents an integer of 2 or greater and 5 or less.)

CH₃(CH₂)ₐ—CH(NH₂)—CH₂—OH (5)
(In Formula (5), a represents an integer of 2 or greater and 5 or less.)

In this manner, it is possible to provide a dispersant-containing liquid that can be used for disintegration and dispersion suitable for an organic coloring material by performing a dispersion treatment for a short time, can reduce the stress on the organic coloring material during the dispersion, and can be used for preparation of an aqueous coloring material dispersion liquid with excellent dispersion stability of the organic coloring material and excellent storage stability. More specific details are as follows. That is, the wettability of the dispersant-containing liquid with respect to the organic coloring material can be improved, and disintegration and crushing of the organic coloring material are easily carried out so that the time required for preparation of the aqueous coloring material dispersion liquid can be reduced. Since disintegration and crushing of the organic coloring material are easily carried out, the stress on the organic coloring material during the dispersion can be reduced, and thus the dispersion stability of the organic coloring material in the aqueous coloring material dispersion liquid and the storage stability of the aqueous coloring material dispersion liquid can be improved. The reason why such excellent effects can be obtained is considered as follows. That is, the above-described specific linear monoalkylamine has a molecular weight less than that of an anionic resin. Therefore, since the diffusion speed of the linear monoalkylamine in a liquid is higher than that of the anionic resin, the linear monoalkylamine quickly reaches the surfaces of particles of the disintegrated organic coloring material when the aqueous coloring material dispersion liquid of the present disclosure is prepared by using the dispersant-containing liquid of the present disclosure, and thus the initial dispersibility of the organic coloring material can be ensured. Thereafter, dispersion is stabilized due to the anionic resin. Accordingly, the above-described excellent effects are considered to be obtained due to the improvement of both the initial dispersibility and the long-term dispersibility of the organic coloring material.

On the contrary, satisfactory results cannot be obtained when the above-described conditions are not satisfied. For example, even in a case where the dispersant-containing liquid contains an anionic resin, when the anionic resin has a structure that does not contain both the carboxyl group and the sulfo group, the water solubility of the anionic resin cannot be sufficiently improved, and accordingly, the dispersion stability of the organic coloring material and the storage stability of the aqueous coloring material dispersion liquid when the aqueous coloring material dispersion liquid containing an organic coloring material is prepared by using the dispersant-containing liquid cannot be sufficiently improved.

Further, even in a case where the dispersant-containing liquid contains an anionic resin containing a carboxyl group and/or a sulfo group as an anionic functional group, when the acid value of the anionic resin is less than the above-described lower limit, the water solubility of the anionic resin cannot be sufficiently increased, and thus the anionic resin cannot sufficiently function as a dispersant. As a result, the dispersion stability of the organic coloring material and the storage stability of the aqueous coloring material dispersion liquid when the aqueous coloring material dispersion liquid containing an organic coloring material is prepared by using the dispersant-containing liquid containing such an anionic resin cannot be sufficiently improved.

Further, even in a case where the dispersant-containing liquid contains an anionic resin containing a carboxyl group and/or a sulfo group as an anionic functional group, when the acid value of the anionic resin is greater than the above-described upper limit, the proportion of the monomer containing no anionic functional group in the anionic resin is extremely small, and thus adsorption of the anionic resin on the organic coloring material is insufficient. As a result, the dispersion stability of the organic coloring material and the storage stability of the aqueous coloring material dispersion liquid when the aqueous coloring material dispersion liquid containing an organic coloring material is prepared by using the dispersant-containing liquid containing such an anionic resin cannot be sufficiently improved.

Further, when the dispersant-containing dispersion liquid does not contain linear monoalkylamine, the time required for the dispersion treatment performed on the organic coloring material increases, and thus the productivity of the aqueous coloring material dispersion liquid is significantly decreased. Further, the stress on the organic coloring material during the dispersion is increased even when the aqueous coloring material dispersion liquid in which the organic coloring material is dispersed is obtained, and as a result, the dispersion stability of the organic coloring material in the aqueous coloring material dispersion liquid and the storage stability of the aqueous coloring material dispersion liquid are degraded.

Further, in a case where the linear monoalkylamine does not correspond to any of the compounds represented by Formulae (1) to (5) even when the dispersant-containing liquid contains the linear monoalkylamine, for example, since the wettability of the anionic resin to the organic coloring material is insufficient, the time required for disintegration and dispersion of the organic coloring material to a target particle diameter is increased, and thus overdispersion occurs. Therefore, the dispersion stability of the organic coloring material in the aqueous coloring material dispersion liquid and the storage stability of the aqueous coloring material dispersion liquid are degraded.

### <1-1> Water

The dispersant-containing liquid of the present disclosure contains water. The water mainly has a function of imparting the fluidity to the dispersant-containing liquid and the aqueous coloring material dispersion liquid prepared by using the dispersant-containing liquid and thus functions as a dispersion medium or a solvent.

It is preferable that ion exchange water, pure water, or ultrapure water be used as water.

The lower limit of the content of water in the dispersant-containing liquid is not particularly limited, but is preferably 20.0% by mass, more preferably 28.0% by mass, and still more preferably 35.0% by mass. Further, the upper limit of the content of water in the dispersant-containing liquid is not particularly limited, but is preferably 99.5% by mass, more preferably 99.0% by mass, and still more preferably 98.0% by mass.

In this manner, the viscosity of the dispersant-containing liquid can be more reliably adjusted to a suitable value. Further, the dispersion stability of the organic coloring material in the aqueous coloring material dispersion liquid prepared by using the dispersant-containing liquid can be further improved.

### <1-2> Anionic Resin Serving as Dispersant

The dispersant-containing liquid of the present disclosure contains a dispersant, particularly an anionic resin as a dispersing resin.

The anionic resin contains a carboxyl group and/or a sulfo group as an anionic functional group and has an acid value of 50 mgKOH/g or greater and 300 mgKOH/g or less.

The lower limit of the acid value of the anionic resin may be 50 mgKOH/g and is preferably 55 mgKOH/g and more preferably 60 mgKOH/g. The upper limit of the acid value of the anionic resin may be 300 mgKOH/g and is preferably 200 mgKOH/g and more preferably 150 mgKOH/g.

In this manner, the above-described effects are more remarkably exhibited.

The anionic resin contains a carboxyl group and/or a sulfo group as an anionic functional group, and the acid value thereof may be in a predetermined range and the basic skeleton thereof is not particularly limited.

The anionic resin may be, for example, an addition polymerization type resin material such as polyolefin, polystyrene, or an acrylic resin or a condensation polymerization type resin material such as polyester, polyamide, or polycarbonate.

Further, the anionic resin may be a homopolymer or a copolymer.

Particularly, when the anionic resin is a copolymer containing, as a constituent monomer, an addition polymerizable monomer that contains the anionic functional group (that is, an addition polymerizable monomer that provides the anionic functional group to the anionic resin), a plurality of kinds of resins can be obtained by copolymerizing a plurality of kinds of monomers, and an effect of providing a dispersant-containing liquid that has achieved long-term dispersion stability can be obtained.

Further, when the anionic resin is a copolymer containing, as a constituent monomer, a condensation polymerizable monomer that contains the anionic functional group (that is, a condensation polymerizable monomer that provides the anionic functional group to the anionic resin), the copolymer containing a condensation polymerizable monomer is likely to obtain bioplastics that provide biodegradability of the resin and use resources derived from organisms as raw materials by selecting the monomer, and an effect of providing a dispersant-containing liquid in which both high environmental performance and long-term dispersion stability are achieved can be obtained.

Examples of the addition polymerizable monomer that provides the anionic functional group to the anionic resin include styrenesulfonic acid, vinylsulfonic acid, acrylamidomethylpropanesulfonic acid, allylsulfonic acid, methallylsulfonic acid, methacryloyloxyethanesulfonic acid, acrylic acid, methacrylic acid, maleic anhydride, monomethyl maleate, monoethyl maleate, monopropyl maleate, monobutyl maleate, fumaric acid, and vinylbenzoic acid, and the addition polymerizable monomer can be used alone or in combination of two or more kinds selected from these.

In this manner, the water solubility of the anionic resin can be further enhanced. Further, the dispersion stability of the organic coloring material when the aqueous coloring material dispersion liquid in which the organic coloring material is dispersed is prepared by using the dispersant-containing liquid can be further improved. Further, when the aqueous coloring material dispersion liquid is an ink jet composition, the color developability of a recorded portion formed by using the ink jet composition can be further improved while the jetting stability of the ink jet composition using an ink jet method is further improved. Further, the water resistance of a recorded portion formed by using the ink jet composition can be further improved.

When the anionic resin is an addition polymerization type resin material, the anionic resin may contain a constituent monomer other than the addition polymerizable monomer that provides the anionic functional group to the anionic resin, that is, an addition polymerizable monomer that does not provide the anionic functional group to the anionic resin.

In this manner, the adsorptivity of the anionic resin for the organic coloring material can be further strengthened.

Examples of such a constituent monomer include styrene, α-methylstyrene, α-ethylstyrene, chlorostyrene, methyl acrylate, ethyl acrylate, propyl acrylate, butyl acrylate, hexyl acrylate, 2-ethylhexyl acrylate, octyl acrylate, benzyl acrylate, phenyl acrylate, methyl methacrylate, ethyl methacrylate, propyl methacrylate, butyl methacrylate, hexyl methacrylate, 2-ethylhexyl methacrylate, octyl methacrylate, benzyl methacrylate, phenyl methacrylate, dibutyl maleate, and dibutyl fumarate, and the constituent monomer can be used alone or in combination of two or more kinds selected from these.

The addition polymerization type anionic resin can be synthesized by any of known polymerization methods such as radical polymerization, anionic polymerization, and cationic polymerization, or the synthesis may be carried out by solution polymerization or bulk polymerization. Further, an emulsion polymerization method or a suspension polymerization method may be used when radical polymerization is carried out.

When the anionic resin is a condensation polymerization resin material, polyester is preferable from the viewpoint of the wide selection range of the monomers.

The polyester can be obtained by a condensation reaction using polycarboxylic acid and a diol as monomers.

Examples of the condensation polymerizable monomer that provides the anionic functional group to a polyester-based anionic resin include a polycarboxylic acid monomer that provides a sulfo group, a diol monomer that provides a sulfo group, a polycarboxylic acid monomer that provides a carboxyl group, and a diol monomer that provides a carboxyl group.

That is, examples of the polycarboxylic acid monomer that provides a sulfo group to a polyester-based anionic resin include sulfoisophthalic acid, sulfoterephthalic acid, sulfophthalic acid, sulfosuccinic acid, sulfomalonic acid, 2,3-disulfosuccinic acid, sulfotartaric acid, sulfomalic acid, sulfomaleic acid, sulfofumaric acid, 1-sulfo-1,2-cyclohexanedicarboxylic acid, and 3-(sodiooxysulfonyl) glutaric acid, lower alkyl ester thereof, and an anhydride.

Further, examples of the diol monomer that provides a sulfo group to a polyester-based anionic resin include 2,3-dihydroxy-1-propanesulfonic acid, 3-[bis(2-hydroxyethyl)amino]-1-propanesulfonic acid, and 2-hydroxy-3-[bis(2-hydroxyethyl)amino]-1-propanesulfonic acid.

Further, examples of the polycarboxylic acid monomer that provides a carboxyl group to a polyester-based anionic resin include tricarballylic acid, β-alanine diacetic acid, trimellitic acid, trimesic acid, pyromellitic acid, and mellophanic acid, lower alkyl ester thereof, and an anhydride.

Further, examples of the diol monomer that provides a carboxyl group to a polyester-based anionic resin include N,N-bis(2-hydroxyethyl)-β-alanine, N,N-bis(2-hydroxyethyl) succinamic acid, and a salt thereof.

When the anionic resin is a condensation polymerization type resin material, the anionic resin may contain a constituent monomer other than the condensation polymerizable monomer that provides the anionic functional group to the anionic resin, that is, a condensation polymerizable monomer that does not provide the anionic functional group to the anionic resin.

In this manner, the adsorptivity of the anionic resin for the organic coloring material can be further strengthened.

Examples of such a constituent monomer include a polycarboxylic acid monomer and a diol monomer as described below.

Examples of the polycarboxylic acid monomer as the condensation polymerizable monomer that does not provide the anionic functional group to the anionic resin include aromatic polycarboxylic acids such as phthalic acid, terephthalic acid, isophthalic acid, 2,5-norbornanedicarboxylic acid, 1,4-naphthalenedicarboxylic acid, biphenyldicarboxylic acid, 4,4′-sulfonyldibenzoic acid, and 2,5-naphthalenedicarboxylic acid, aliphatic polycarboxylic acids such as oxalic acid, malonic acid, glutaric acid, adipic acid, pimelic acid, azelaic acid, sebacic acid, fumaric acid, maleic acid, itaconic acid, 1,3-cyclopentanedicarboxylic acid, 1,2-cyclohexanedicarboxylic acid, 1,3-cyclohexanedicarboxylic acid, and 1,4-cyclohexanedicarboxylic acid, lower alkyl ester thereof, and an anhydride.

Examples of the diol monomer as the condensation polymerizable monomer that does not provide the anionic functional group to the anionic resin include aliphatic polyols such as ethylene glycol, diethylene glycol, triethylene glycol, polyethylene glycol, propylene glycol, dipropylene glycol, tripropylene glycol, polypropylene glycol, 1,3-propanediol, neopentyl glycol, 1,3-butanediol, 1,4-butanediol, 1,5-pentanediol, 1,6-hexanediol, 2,2,4-trimethyl-1,6-hexanediol, 1,2-cyclohexanedimethanol, 1,3-cyclohexanedimethanol, 1,4-cyclohexanedimethanol, and 2,2′-bis(4-hydroxycyclohexyl) isopropane, and aromatic polyols such as 1,4-benzenedimethanol, 1,3-benzenedimethanol, 1,2-benzenedimethanol, biphenol, 4,4′-methylenebisphenol, 2,2-di(p-hydroxyphenyl) propane, styrene glycol, 2-phenyl-1,3-propanediol, and naphthalenediol.

For example, a known polyester synthesis method can be used for synthesis of the condensation polymerization type anionic resin and particularly for the synthesis of polyester as the anionic resin, and the synthesis can be carried out by using melt condensation polymerization, solution condensation polymerization, or solid phase condensation polymerization. Further, a catalyst may be used to increase the reaction efficiency during the condensation reaction.

The lower limit of the number average molecular weight of the anionic resin is preferably 2,000, more preferably 2,500, and still more preferably 3,000. The upper limit of the number average molecular weight of the anionic resin is preferably 70,000, more preferably 50,000, and still more preferably 30,000.

With such a configuration, the water solubility of the anionic resin serving as a dispersant can be further improved, and the dispersion stability of the organic coloring material when the aqueous coloring material dispersion liquid in which the organic coloring material is dispersed is prepared by using the dispersant-containing liquid can be further improved. Further, the viscosity of the dispersant-containing liquid or the aqueous coloring material dispersion liquid prepared by using the dispersant-containing liquid can be adjusted to be in a more suitable range, and for example, when the aqueous coloring material dispersion liquid is an ink jet composition, the color developability of the recorded portion formed by using the ink jet composition can be further improved while the jetting stability of the ink jet composition using an ink jet method is further improved.

The number average molecular weight can be determined by measurement using gel permeation chromatography.

The lower limit of the content of the anionic resin in the dispersant-containing liquid is preferably 0.5% by mass, more preferably 1.0% by mass, and still more preferably 2.0% by mass. Further, the upper limit of the content of the anionic resin in the dispersant-containing liquid is preferably 50.0% by mass, more preferably 45.0% by mass, and still more preferably 40.0% by mass.

In this manner, the dispersion stability of the organic coloring material when the aqueous coloring material dispersion liquid in which the organic coloring material is dispersed is prepared by using the dispersant-containing liquid can be further improved. Further, the viscosity of the dispersant-containing liquid or the aqueous coloring material dispersion liquid prepared by using the dispersant-containing liquid can be adjusted to be in a more suitable range, and for example, when the aqueous coloring material dispersion liquid is an ink jet composition, the color developability of the recorded portion formed by using the ink jet composition can be further improved while the jetting stability of the ink jet composition using an ink jet method is further improved.

### <1-3> Linear Monoalkylamine

The dispersant-containing liquid of the present disclosure contains at least one linear monoalkylamine selected from the group consisting of a compound represented by Formula (1), a compound represented by Formula (2), a compound represented by Formula (3), a compound represented by Formula (4), and a compound represented by Formula (5).

Since such specific linear monoalkylamine has a surfactant-like chemical structure containing both a terminal alkyl group which is a hydrophobic group and a hydrophilic group, the linear monoalkylamine functions as a resin neutralizer neutralizing the anionic group of the anionic resin so that the anionic resin has water solubility, and also functions as an auxiliary organic coloring material dispersant.

In a case where the dispersant-containing liquid contains the specific linear monoalkylamine along with the above-described anionic resin, an increase in viscosity of the aqueous coloring material dispersion liquid and generation of foreign matter in the aqueous coloring material dispersion liquid when the aqueous coloring material dispersion liquid is prepared by using the dispersant-containing liquid can be suppressed. Further, the time required for disintegration and dispersion of the coloring material can be reduced as compared with when the coloring material is disintegrated and dispersed by using only an anionic resin as a dispersant, and thus overdispersion can be suppressed. A decrease in dispersion stability due to the overdispersion can be avoided by suppressing the overdispersion.

All a′ in Formulae (1) to (5) may represent an integer of 2 or greater and 5 or less, preferably 3 or 4, and more preferably 3.

In this manner, the above-described effects are more remarkably exhibited.

Further, b in Formula (1) may represent 2 or 3 and preferably 2.

In this manner, the above-described effects are more remarkably exhibited.

Further, c in Formula (2) may represent an integer of 1 or greater and 3 or less, preferably 2 or 3, and more preferably 3.

In this manner, the above-described effects are more remarkably exhibited.

The lower limit of the content of the linear monoalkylamine in the dispersant-containing liquid is preferably 0.05% by mass, more preferably 0.1% by mass, and still more preferably 0.2% by mass. Further, the upper limit of the content of the linear monoalkylamine in the dispersant-containing liquid is preferably 30.0% by mass, more preferably 27.0% by mass, and still more preferably 25.0% by mass.

In this manner, the dispersion stability of the organic coloring material when the aqueous coloring material dispersion liquid in which the organic coloring material is dispersed is prepared by using the dispersant-containing liquid can be further improved. Further, the viscosity of the dispersant-containing liquid or the aqueous coloring material dispersion liquid prepared by using the dispersant-containing liquid can be adjusted to be in a more suitable range, and for example, when the aqueous coloring material dispersion liquid is an ink jet composition, the color developability of the recorded portion formed by using the ink jet composition can be further improved while the jetting stability of the ink jet composition using an ink jet method is further improved. Further, disintegration and dispersion of the organic coloring material can be suitably carried out by performing a dispersion treatment for a shorter time, and thus the productivity of the aqueous coloring material dispersion liquid is further improved.

The content of the anionic resin and the content of the linear monoalkylamine added to the dispersant-containing liquid are set to 50% by mole or greater and 125% by mole or less with respect to the acid value of the anionic resin.

In this manner, the dispersion stability of the organic coloring material when the aqueous coloring material dispersion liquid in which the organic coloring material is dispersed is prepared by using the dispersant-containing liquid can be further improved. Further, the viscosity of the dispersant-containing liquid or the aqueous coloring material dispersion liquid prepared by using the dispersant-containing liquid can be adjusted to be in a more suitable range, and for example, when the aqueous coloring material dispersion liquid is an ink jet composition, the color developability of the recorded portion formed by using the ink jet composition can be further improved while the jetting stability of the ink jet composition using an ink jet method is further improved. Further, disintegration and dispersion of the organic coloring material can be suitably carried out by performing a dispersion treatment for a shorter time, and thus the productivity of the aqueous coloring material dispersion liquid is further improved.

### <1-4> Other Components

The dispersant-containing liquid of the present disclosure may contain components other than the above-described components. Hereinafter, such components will be referred to as “other components” in this section.

Examples of other components include dispersants and resin components other than the anionic resin, solvents other than water, moisturizers, surface tension adjusters, pH adjusters, preservatives, and chelating agents, and the other components can be used alone or in combination of two or more kinds selected from these.

Here, the dispersant-containing liquid of the present disclosure does not contain at least one organic coloring material selected from the group consisting of a pigment, a disperse dye, and an oil-based dye. The aqueous coloring material dispersion liquid of the present disclosure described below contains an organic coloring material in addition to the constituent components of the dispersant-containing liquid of the present disclosure described above.

Further, the content of the other components in the dispersant-containing liquid of the present disclosure is preferably 50.0% by mass or less, more preferably 45.0% by mass or less, and still more preferably 40.0% by mass or less.

### <1-5> Other Conditions

It is preferable that the dispersant-containing liquid of the present disclosure satisfy the conditions described below.

For example, the lower limit of the pH of the dispersant-containing liquid according to the present disclosure at 20° C. is preferably 7.0, more preferably 7.2, and still more preferably 7.4. Further, the upper limit of the pH of the dispersant-containing liquid according to the present disclosure at 20° C. is preferably 11.0, more preferably 10.5, and still more preferably 10.0.

In this manner, a more suitable dissolved state of the anionic resin can be ensured, and thus, for example, problems of aggregation, sedimentation, and the like due to insolubilization of the anionic resin can be more effectively prevented. As a result, for example, the dispersion stability of the organic coloring material when the aqueous coloring material dispersion liquid containing the organic coloring material is prepared by using the dispersant-containing liquid can be further improved. Further, when the aqueous coloring material dispersion liquid is an ink jet composition, the jetting stability of the ink jet composition using an ink jet method can be further improved.

The dispersant-containing liquid of the present disclosure can be suitably prepared, for example, by adding required components such as water and the linear monoalkylamine to the anionic resin and stirring the mixture. Further, the mixture may be heated as necessary when the mixture is stirred.

### <2> Aqueous Coloring Material Dispersion Liquid

Next, the aqueous coloring material dispersion liquid of the present disclosure will be described.

The aqueous coloring material dispersion liquid of the present disclosure contains at least one organic coloring material selected from the group consisting of a pigment, a disperse dye, and an oil-soluble dye, an anionic resin containing a carboxyl group and/or a sulfo group and having an acid value of 50 mgKOH/g or greater and 300 mgKOH/g or less as an anionic functional group, linear monoalkylamine, and water. Further, the linear monoalkylamine is at least one selected from the group consisting of a compound represented by Formula (1), a compound represented by Formula (2), a compound represented by Formula (3), a compound represented by Formula (4), and a compound represented by Formula (5).

CH₃(CH₂)ₐ—NH—(CH₂)_{b}—OH (1)
(In Formula (1), a represents an integer of 2 or greater and 5 or less, and b represents 2 or 3.)

CH₃(CH₂)ₐ—O—(CH₂)_{c}—NH₂ (2)
(In Formula (2), a represents an integer of 2 or greater and 5 or less, and c represents an integer of 1 or greater and 3 or less.)

CH₃(CH₂)ₐ—(O—CH₂CH₂)₂—NH₂ (3)
(In Formula (3), a represents an integer of 2 or greater and 5 or less.)

CH₃(CH₂)ₐ—CH(OH)—CH₂—NH₂ (4)
(In Formula (4), a represents an integer of 2 or greater and 5 or less.)

CH₃(CH₂)ₐ—CH(NH₂)—CH₂—OH (5)
(In Formula (5), a represents an integer of 2 or greater and 5 or less.)

In this manner, the aqueous coloring material dispersion liquid with excellent dispersion stability of the organic coloring material and excellent storage stability can be provided. Further, even when the aqueous coloring material dispersion liquid contains a moisturizer and a surface tension adjuster, the affinity and the adsorptivity for the organic coloring material do not compete with each other between the moisturizer and the surface tension adjuster, and thus the dispersion stability of the organic coloring material is not adversely affected, which is suitable.

### <2-1> Water

The aqueous coloring material dispersion liquid of the present disclosure contains water. The water mainly has a function of imparting fluidity to the aqueous coloring material dispersion liquid and functions as a dispersion medium and a solvent.

It is preferable to use ion exchange water, pure water, or ultrapure water as water.

The lower limit of the content of water in the aqueous coloring material dispersion liquid is not particularly limited, but is preferably 20.0% by mass, more preferably 28.0% by mass, and still more preferably 35.0% by mass. Further, the upper limit of the content of water in the dispersant-containing liquid is not particularly limited, but is preferably 97.0% by mass, more preferably 94.0% by mass, and still more preferably 92.0% by mass.

In this manner, the viscosity of the aqueous coloring material dispersion liquid can be more reliably adjusted to a suitable value. Further, the dispersion stability of the organic coloring material in the aqueous coloring material dispersion liquid can be further improved.

### <2-2> Anionic Resin Serving as Dispersant

The aqueous coloring material dispersion liquid of the present disclosure contains an anionic resin containing a carboxyl group and/or a sulfo group and having an acid value of 50 mgKOH/g or greater and 300 mgKOH/g or less as an anionic functional group.

It is preferable that such an anionic resin satisfy the same conditions as described in the section <1-2> above.

In this manner, the same effects as described above can be obtained.

The lower limit of the content of the anionic resin in the aqueous coloring material dispersion liquid is preferably 0.1% by mass, more preferably 0.2% by mass, and still more preferably 0.25% by mass. Further, the upper limit of the content of the anionic resin in the aqueous coloring material dispersion liquid is preferably 40.0% by mass, more preferably 35.0% by mass, and still more preferably 30.0% by mass.

In this manner, the dispersion stability of the organic coloring material can be further improved. Further, the viscosity of the aqueous coloring material dispersion liquid can be adjusted to be in a more suitable range, and for example, when the aqueous coloring material dispersion liquid is an ink jet composition, the color developability of the recorded portion formed by using the ink jet composition can be further improved while the jetting stability of the ink jet composition using an ink jet method is further improved.

Further, the lower limit of the content of the anionic resin is preferably 10.0 parts by mass, more preferably 15.0 parts by mass, and still more preferably 20.0 parts by mass with respect to 100.0 parts by mass of the organic coloring material contained in the aqueous coloring material dispersion liquid. Further, the upper limit of the content of the anionic resin is preferably 250.0 parts by mass, more preferably 200.0 parts by mass, and still more preferably 150.0 parts by mass with respect to 100.0 parts by mass of the organic coloring material contained in the aqueous coloring material dispersion liquid.

In this manner, the viscosity of the aqueous coloring material dispersion liquid is likely to be adjusted to be in a suitable range, the handleability of the aqueous coloring material dispersion liquid can be further improved, and the dispersion stability of the organic coloring material can be further improved.

<2-3> Linear monoalkylamine

The aqueous coloring material dispersion liquid of the present disclosure contains at least one linear monoalkylamine selected from the group consisting of a compound represented by Formula (1), a compound represented by Formula (2), a compound represented by Formula (3), a compound represented by Formula (4), and a compound represented by Formula (5).

It is preferable that such linear monoalkylamine satisfy the same conditions as described in the section <1-3> above.

In this manner, the same effects as described above can be obtained.

The lower limit of the content of the linear monoalkylamine in the aqueous coloring material dispersion liquid is preferably 0.01% by mass, more preferably 0.02% by mass, and still more preferably 0.04% by mass. Further, the upper limit of the content of the linear monoalkylamine in the aqueous coloring material dispersion liquid is preferably 24.0% by mass, more preferably 22.0% by mass, and still more preferably 20.0% by mass.

In this manner, the dispersion stability of the organic coloring material can be further improved. Further, the viscosity of the aqueous coloring material dispersion liquid can be adjusted to be in a more suitable range, and for example, when the aqueous coloring material dispersion liquid is an ink jet composition, the color developability of the recorded portion formed by using the ink jet composition can be further improved while the jetting stability of the ink jet composition using an ink jet method is further improved.

The content of the anionic resin and the content of the linear monoalkylamine added to the aqueous coloring material dispersion liquid are set to 50% by mole or greater and 125% by mole or less with respect to the acid value of the anionic resin.

In this manner, the dispersion stability of the organic coloring material in the aqueous coloring material dispersion liquid can be further improved. Further, the viscosity of the aqueous coloring material dispersion liquid can be adjusted to be in a more suitable range, and for example, when the aqueous coloring material dispersion liquid is an ink jet composition, the color developability of the recorded portion formed by using the ink jet composition can be further improved while the jetting stability of the ink jet composition using an ink jet method is further improved.

### <2-4> Organic Coloring Material

The aqueous coloring material dispersion liquid of the present disclosure contains at least one organic coloring material selected from the group consisting of a pigment, a disperse dye, and an oil-soluble dye.

Examples of the pigment include a quinacridone-based pigment, a quinacridonequinone-based pigment, a dioxazine-based pigment, a phthalocyanine-based pigment, an anthrapyrimidine-based pigment, an anthanthrone-based pigment, an indanthrone-based pigment, a flavanthrone-based pigment, a perylene-based pigment, a diketopyrrolopyrrole-based pigment, a perinone-based pigment, a quinophthalone-based pigment, an anthraquinone-based pigment, a thioindigo-based pigment, a benzimidazolone-based pigment, an isoindolinone-based pigment, an azomethine-based pigment, an azo-based pigment, and carbon black.

More specifically, examples of a yellow pigment include C.I. Pigment Yellow 1, 2, 3, 4, 5, 6, 7, 10, 11, 12, 13, 14, 14C, 16, 17, 24, 34, 35, 37, 42, 53, 55, 65, 73, 74, 75, 81, 83, 93, 95, 97, 98, 100, 101, 104, 108, 109, 110, 114, 117, 120, 128, 129, 138, 150, 151, 153, 154, and 180. Examples of a magenta pigment include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 48 (Ca), 48 (Mn), 48:2, 48:3, 48:4, 49, 49:1, 50, 51, 52, 52:2, 53, 53:1, 55, 57 (Ca), 57:1, 60, 60:1, 63:1, 63:2, 64, 64:1, 81, 83, 87, 88, 89, 90, 101, 104, 105, 106, 108, 112, 114, 122, 123, 146, 149, 163, 166, 168, 170, 172, 177, 178, 179, 184, 185, 190, 193, 202, 209, and 219. Examples of a cyan pigment include C.I. Pigment Blue 1, 2, 3, 15, 15:1, 15:2, 15:3, 15:34, 16, 17:1, 22, 25, 56, and 60, and C.I. Vat Blue 4, 60, and 63. Examples of other color pigments include C.I. Pigment Orange 5, 13, 16, 17, 36, 43, and 51, C.I. Pigment Green 1, 4, 7, 8, 10, 17, 18, and 36, and C.I. Pigment Violet 1, 3, 5:1, 16, 19, 23, and 38.

Examples of the disperse dye include C.I. Disperse Red 60, 82, 86, 86:1, 167:1, 279, and 364, C.I. Disperse Yellow 54, 64, 71, 86, 114, 153, 232, 233, and 245, C.I. Disperse Blue 27, 60, 73, 77, 77:1, 87, 257, 359, and 367, C.I. Disperse Violet 26, 33, 36, and 57, and C.I. Disperse Orange 30, 41, and 61.

Examples of the oil-soluble dye include C.I. Solvent Yellow 16, 21, 25, 29, 33, 51, 56, 82, 88, 89, 150, 160:1, and 163, C.I. Solvent Red 7, 8, 18, 24, 27, 49, 109, 122, 125, 127, 130, 132, 135, 218, 225, and 230, C.I. Solvent Blue 14, 25, 35, 38, 48, 67, 68, 70, and 132, and C.I. Solvent Black 3, 5, 7, 27, 28, 29, and 34.

It is preferable that the organic coloring material contained in the aqueous coloring material dispersion liquid of the present disclosure be any of the disperse dye or the oil-soluble dye.

In this manner, the dispersion stability of the organic coloring material in the aqueous coloring material dispersion liquid can be further improved. Further, the aqueous coloring material dispersion liquid of the present disclosure can be suitably applied to an ink jet composition, and the color developability and the like of the recorded portion formed by using the ink jet composition can be further improved.

The lower limit of the average particle diameter of the organic coloring material contained in the aqueous coloring material dispersion liquid of the present disclosure is preferably 25 nm, more preferably 30 nm, and still more preferably 35 nm. Further, the upper limit of the average particle diameter of the organic coloring material contained in the aqueous coloring material dispersion liquid of the present disclosure is preferably 750 nm, more preferably 600 nm, and still more preferably 500 nm.

In this manner, the dispersion stability of the organic coloring material in the aqueous coloring material dispersion liquid and the storage stability of the aqueous coloring material dispersion liquid can be further improved.

Further, in the present specification, the average particle diameter denotes the average particle diameter in terms of the volume unless otherwise specified. Further, the average particle diameter can be determined by performing measurement using, for example, MICROTRAC UPA (manufactured by Nikkiso Co., Ltd.).

The content of the organic coloring material in the aqueous coloring material dispersion liquid of the present disclosure is not particularly limited, but the lower limit of the content of the organic coloring material in the aqueous coloring material dispersion liquid of the present disclosure is preferably 0.3% by mass, more preferably 0.4% by mass, and still more preferably 0.5% by mass. Further, the upper limit of the content of the organic coloring material in the aqueous coloring material dispersion liquid of the present disclosure is preferably 40.0% by mass, more preferably 30.0% by mass, and still more preferably 20.0% by mass.

In this manner, the dispersion stability of the organic coloring material can be further improved while the content of the organic coloring material in the aqueous coloring material dispersion liquid is sufficiently increased. Further, the viscosity of the aqueous coloring material dispersion liquid to be obtained is likely to be adjusted to be in a more suitable range when the organic coloring material is dispersed using, for example, a disperser such as a bead mill. Further, when the aqueous coloring material dispersion liquid is an ink composition such as an ink jet composition, the jetting stability of the ink composition and the color developability of the recorded portion formed using the ink composition can be further improved.

The content of the anionic resin and the content of the organic coloring material in the aqueous coloring material dispersion liquid are determined based on a suitable ratio that is determined by a combination of the anionic resin and the organic coloring material. The lower limit of the content of the anionic resin is preferably 10.0 parts by mass, more preferably 15.0 parts by mass, and still more preferably 20.0 parts by mass with respect to 100.0 parts by mass of the organic coloring material contained in the aqueous coloring material dispersion liquid. Further, the upper limit of the content of the anionic resin is preferably 250.0 parts by mass, more preferably 200.0 parts by mass, and still more preferably 150.0 parts by mass with respect to 100.0 parts by mass of the organic coloring material contained in the aqueous coloring material dispersion liquid.

In this manner, the dispersion stability of the organic coloring material can be further improved while the content of the organic coloring material in the aqueous coloring material dispersion liquid is sufficiently increased. Further, the viscosity of the aqueous coloring material dispersion liquid to be obtained is likely to be adjusted to be in a more suitable range when the organic coloring material is dispersed using, for example, a disperser such as a bead mill. Further, when the aqueous coloring material dispersion liquid is an ink composition such as an ink jet composition, the jetting stability of the ink composition and the color developability of the recorded portion formed using the ink composition can be further improved.

### <2-5> Moisturizer

The aqueous coloring material dispersion liquid of the present disclosure may contain a moisturizer.

Examples of the moisturizer include polyols such as diethylene glycol, triethylene glycol, tetraethylene glycol, pentaethylene glycol, trimethylene glycol, 2-butene-1,4-diol, 2-ethyl-1,3-hexanediol, 2-methyl-2,4-pentanediol, tripropylene glycol, isobutylene glycol, glycerin, diglycerin, mesoerythritol, trimethylolpropane, ditrimethylolpropane, pentaerythritol, and dipentaerythritol, saccharides such as monosaccharides, disaccharides, oligosaccharides, and polysaccharides, such as glucose, mannose, fructose, ribose, xylose, arabinose, galactose, aldonic acid, glucitol (sorbitol), maltose, cellobiose, lactose, sucrose, trehalose, and maltotriose, and derivatives of these saccharides, and betaines such as glycine and trimethyl glycine. Further, the moisturizer can be used alone or in combination of two or more kinds selected from these.

The content of the moisturizer in the aqueous coloring material dispersion liquid of the present disclosure is not particularly limited, but the lower limit of the content of the moisturizer in the aqueous coloring material dispersion liquid of the present disclosure is preferably 3.0% by mass, more preferably 5.0% by mass, and still more preferably 7.0% by mass. Further, the upper limit of the content of the moisturizer in the aqueous coloring material dispersion liquid of the present disclosure is preferably 40.0% by mass, more preferably 35.0% by mass, and still more preferably 30.0% by mass.

### <2-6> Surface Tension Adjuster

The aqueous coloring material dispersion liquid of the present disclosure may contain a surface tension adjuster.

Examples of the surface tension adjuster include a surfactant.

Particularly, in a case where the aqueous coloring material dispersion liquid of the present disclosure is an ink jet ink, an effect of controlling the permeability and the wettability with respect to the recording medium and adjusting the drying time for the ink can be obtained when the aqueous coloring material dispersion liquid contains the moisturizer and the surface tension adjuster described above.

Examples of the surfactant include a cationic surfactant, an anionic surfactant, and a nonionic surfactant, but a nonionic surfactant is particularly preferable from the viewpoint of suppressing the influence on the solubility of the anionic resin that is anionically dissolved.

Examples of a nonionic non-reactive surfactant include a silicone-based surfactant, a fluorine-based surfactant, and an acetylene glycol-based surfactant.

Examples of the silicone-based surfactant include BYK-306, BYK-307, BYK-333, BYK-341, BYK-345, BYK-346, BYK-348, BYK-349, and BYK-3455 (all manufactured by BYK Japan K.K.), SILFACE SAG503A, SAG002, SAG005, and SAG014 (all manufactured by Nissin Chemical Co., Ltd.), KF-351A, KF-352A, KF-353, KF-354L, KF-355A, KF-615A, KF-945, KF-640, KF-642, KF-643, KF-6020, X-22-4515, KF-6011, and KF-6012 (all manufactured by Shin-Etsu Chemical Co., Ltd.).

Examples of the fluorine-based surfactant include FC-4430 and FC-4432 (both manufactured by 3M Japan Limited), MEGAFACE F-444, F-477, F-553, and F-556 (all manufactured by DIC Corporation), and SURFLON S-241, S-242, S-243, and S-386 (all manufactured by AGC Seimi Chemical Co., Ltd.).

Examples of the acetylene glycol-based surfactant include SURFYNOL 82, 465, 485, and 2502, OLFINE E1004, E1010, E1020, PD-002W, PD-004, EXP4001, EXP4002, EXP4123, and EXP4300 (all manufactured by Nissin Chemical Co., Ltd.), and ACETYLENOL E00, E103T, E40, E60, E100, and E200 (all manufactured by Kawaken Fine Chemicals Co., Ltd.).

Further, examples of the surface tension adjuster include water-soluble compounds, for example, lower alcohol such as 2-propanol, 1-propanol, 2-butanol, or 1-butanol, glycol monoethers such as diethylene glycol monobutyl ether, triethylene glycol monobutyl ether, propylene glycol monobutyl ether, dipropylene glycol monobutyl ether, ethylene glycol mono-2-ethyl hexyl ether, and diethylene glycol mono-2-ethylhexyl ether, 1,2-diols such as 1,2-pentanediol, 1,2-hexanediol, and 1,2-octanediol, and glycerin monoether such as glycerin monobutyl ether or glycerin-2-ethylhexyl ether.

The content of the surface tension adjuster in the aqueous coloring material dispersion liquid of the present disclosure is not particularly limited, but the lower limit of the content of the surface tension adjuster in the aqueous coloring material dispersion liquid of the present disclosure is preferably 0.01% by mass, more preferably 0.05% by mass, and still more preferably 0.1% by mass. Further, the upper limit of the content of the surface tension adjuster in the aqueous coloring material dispersion liquid of the present disclosure is preferably 20.0% by mass, more preferably 15.0% by mass, and still more preferably 10.0% by mass.

### <2-7> Other Components

The aqueous coloring material dispersion liquid of the present disclosure may further contain components other than the above-described components. Hereinafter, such components will be referred to as “other components” in this section.

Examples of other components include pH adjusters, preservatives, chelating agents, dispersants and resin components other than the anionic resin, and solvents other than water, and the other components can be used alone or in combination of two or more kinds selected from these.

The pH adjuster is added to adjust, for example, the pH of the aqueous coloring material dispersion liquid to weakly alkaline.

Examples of the pH adjuster include a monovalent inorganic alkali and an organic amine.

For example, ammonia water, lithium hydroxide, sodium hydroxide, or potassium hydroxide is preferable as the monovalent inorganic alkali. Examples of the organic amine include monoethylamine, diethylamine, triethylamine, monoethanolamine, diethanolamine, triethanolamine, diisopropanolamine, triisopropanolamine, butyldiethanolamine, ethyldiethanolamine, 2-amino-2-ethyl-1,3-propanediol, and aminomethylpropanol.

When the aqueous coloring material dispersion liquid contains a preservative, for example, putrefaction of the aqueous coloring material dispersion liquid due to microorganisms can be prevented, and precipitation and aggregation of the solid content in the aqueous coloring material dispersion liquid can be more effectively prevented.

Examples of the preservative include methylisothiazolinone, chloromethylisothiazolinone, octylisothiazolinone, dichlorooctylisothiazolinone, benzisothiazolinone, dicyclohexylamine, iodopropynyl butylcarbamate, and diethylene oximide.

When the aqueous coloring material dispersion liquid contains a chelating agent, for example, polyvalent cations in the aqueous coloring material dispersion liquid are trapped, and precipitation and aggregation of the solid content in the aqueous coloring material dispersion liquid can be more effectively prevented.

Examples of the chelating agent include ethylenediaminetetraacetate, diethylenetriaminetetraacetate, pentetate, iminodisuccinate, and aspartic acid diacetate.

Here, the content of the other components in the aqueous coloring material dispersion liquid of the present disclosure is preferably 15.0% by mass or less, more preferably 12.0% by mass or less, and still more preferably 10.0% by mass or less.

### <2-8> Other Conditions

It is preferable that the aqueous coloring material dispersion liquid of the present disclosure satisfy the conditions described below.

For example, the lower limit of the pH of the aqueous coloring material dispersion liquid according to the present disclosure at 20° C. is preferably 7.0, more preferably 7.2, and still more preferably 7.4. Further, the upper limit of the pH of the aqueous coloring material dispersion liquid according to the present disclosure at 20° C. is preferably 11.0, more preferably 10.5, and still more preferably 10.0.

In this manner, a more suitable dissolved state of the anionic resin can be ensured, and thus, for example, problems of aggregation, sedimentation, and the like due to insolubilization of the anionic resin can be more effectively prevented. As a result, for example, the dispersion stability of the organic coloring material in the aqueous coloring material dispersion liquid can be further improved. Further, when the aqueous coloring material dispersion liquid is an ink jet composition, the jetting stability of the ink jet composition using an ink jet method can be further improved.

The aqueous coloring material dispersion liquid of the present disclosure may be used for any applications such as a coating material or various ink compositions, but it is preferable that the aqueous coloring material dispersion liquid be an ink jet composition, particularly an ink jet ink.

In an ink jet ink, sedimentation or aggregation of the organic coloring material in the composition, precipitation of the solid content in an ink jet head or a flow path, and the like greatly affect the jetting stability using an ink jet method, and in some cases, jetting of the composition using an ink jet method may be impossible to carry out. That is, the ink jet composition is required to have both the dispersion stability and the drying resistance of the organic coloring material at higher levels. On the contrary, in the present disclosure, both the dispersion stability and the drying resistance of the organic coloring material can be suitably achieved. That is, the effects of the present disclosure are more remarkably exhibited when the aqueous coloring material dispersion liquid is an ink jet ink. Further, in the present specification, the concept of the ink jet composition includes a stock solution and the like of an ink jet ink, which are used to prepare an ink jet ink by being mixed with other components, in addition to an ink jet ink itself to be jetted by an ink jet method.

The lower limit of the viscosity of the aqueous coloring material dispersion liquid of the present disclosure at 20° C. is not particularly limited, but is preferably 2.0 mPa·s and more preferably 3.0 mPa·s. Further, the upper limit of the viscosity of the aqueous coloring material dispersion liquid of the present disclosure at 20° C. is not particularly limited, but is preferably 500 mPa·s, more preferably 300 mPa·s, and still more preferably 200 mPa·s.

In this manner, for example, when the aqueous coloring material dispersion liquid of the present disclosure is an ink jet composition, the jetting stability thereof can be further improved.

Further, the viscosity can be measured by increasing the shear rate from 10 [s⁻¹] to 1,000 [s⁻¹] at 20° C. using a viscoelasticity tester such as MCR-300 (manufactured by Physica) and reading the viscosity when the shear rate reaches 200.

The lower limit of the surface tension of the aqueous coloring material dispersion liquid of the present disclosure at 20° C. is not particularly limited, but is preferably 20 mN/m. Further, the upper limit of the surface tension of the aqueous coloring material dispersion liquid of the present disclosure at 20° C. is not particularly limited, but is preferably 50 mN/m, more preferably 45 mN/m, and still more preferably 40 mN/m.

In this manner, for example, when the aqueous coloring material dispersion liquid of the present disclosure is an ink jet composition, clogging or the like of a nozzle of a recording device using an ink jet method is unlikely to occur, and thus the jetting stability of the aqueous coloring material dispersion liquid of the present disclosure is further improved. Further, even when a nozzle is clogged, recovery properties can be further improved by capping the nozzle.

Further, a value measured by a Wilhelmy method can be employed as the surface tension. The surface tension can be measured by using, for example, a surface tension meter such as CBVP-7 (manufactured by Kyowa Interface Science Co., Ltd.).

When the aqueous coloring material dispersion liquid of the present disclosure is an ink jet ink, the ink is typically applied to a recording device using an ink jet method in a state of being accommodated in a container such as a cartridge, a bag, or a tank. In other words, the recording device according to the present disclosure includes a container such as an ink cartridge that accommodates an ink jet ink serving as the aqueous coloring material dispersion liquid of the present disclosure.

The aqueous coloring material dispersion liquid of the present disclosure can be prepared by miniaturizing the organic coloring material using a bead mill or the like in a state where the above-described dispersant-containing liquid of the present disclosure is mixed with the organic coloring material that is formed into a dispersoid.

The miniaturization treatment may be performed in multiple stages. In this manner, the organic coloring material is more efficiently miniaturized and can be suitably dispersed.

For example, various inorganic beads such as zirconia beads, stainless steel beads, and alumina beads can be suitably used as the beads.

For example, components such as water, a solvent, a moisturizer, and a surface tension adjuster may be used in addition to the dispersant-containing liquid of the present disclosure and the organic coloring material described above when the aqueous coloring material dispersion liquid of the present disclosure is prepared.

The aqueous coloring material dispersion liquid of the present disclosure may be heated as necessary when prepared.

Further, the method of preparing the aqueous coloring material dispersion liquid according to the present disclosure is not limited to the above-described method. For example, the aqueous coloring material dispersion liquid of the present disclosure may be prepared by mixing required components such as the above-described anionic resin, the organic coloring material, the above-described linear monoalkylamine, and water at once or sequentially adding and mixing the required components in predetermined order without using the above-described dispersant-containing liquid of the present disclosure and miniaturizing the organic coloring material with a bead mill or the like.

Hereinbefore, the suitable embodiments of the present disclosure have been described, but the present disclosure is not limited thereto.

### EXAMPLES

Next, specific examples of the present disclosure will be described.

### <3> Synthesis of Anionic Resin

### Synthesis Example 1

First, 100 mL of dimethylformamide serving as a polymerization solvent, 14 g (15 mol %) of maleic anhydride serving as an anionic functional group monomer, 73 g (70 mol %) of styrene and 34 g (15 mol %) of dibutyl maleate serving as monomers containing no water-soluble functional group, and 0.2 g of azobisisobutyronitrile serving as a polymerization initiator were placed in a flask, stirred, and dissolved at room temperature while the solution was bubbled with nitrogen gas.

Thereafter, the solution was heated to 70° C. and subjected to a polymerization reaction for 6 hours. The reaction solution was cooled to room temperature and added dropwise to hexane, thereby obtaining a white solid. The solid was recovered by filtration and vacuum-dried, thereby obtaining an anionic resin.

The acid value of the obtained anionic resin was 130 mgKOH/g, and the number average molecular weight of the obtained anionic resin was 15,000. The acid value was measured in conformity with JIS K 0070, and the number average molecular weight was determined by dissolving the anionic resin in tetrahydrofuran and performing measurement using gel permeation chromatography. The acid value and the number average molecular weight of anionic resins of Synthesis Examples 2 to 4 were determined in the same manners as described above.

### Synthesis Example 2

An anionic resin was obtained in the same manner as in Synthesis Example 1 except that the anionic functional group monomer used for synthesis of the anionic resin was changed to 7 g (10 mol %) of acrylic acid and 21 g (10 mol %) of acrylamidomethylpropanesulfonic acid and the monomer containing no water-soluble functional group used for synthesis of the anionic resin was changed to 83 g (80 mol %) of styrene.

The acid value of the obtained anionic resin was 100 mgKOH/g, and the number average molecular weight of the obtained anionic resin was 20,000.

### Synthesis Example 3

First, 40 g (15 mol %) of 5-sulfoisophthalic acid serving as an anionic functional group monomer, 58 g (35 mol %) of terephthalic acid serving as a polycarboxylic acid monomer, 31 g (50 mol %) of ethylene glycol serving as a diol, and 0.1 g of tetrabutoxy titanate serving as a catalyst were placed in an autoclave, and the mixture was heated at 150° C. to 200° C. for 3 hours and subjected to a transesterification reaction.

Next, the pressure of the system was gradually reduced at a temperature of 200° C. to distill off diol components, the pressure thereof was set to 10 mmHg after 30 minutes, and a polymerization reaction was continued for 90 minutes. After the reaction, the temperature was cooled to room temperature, thereby obtaining an anionic resin.

The acid value of the obtained anionic resin was 70 mgKOH/g, and the number average molecular weight of the obtained anionic resin was 6,000.

### Synthesis Example 4

An anionic resin was obtained in the same manner as in Synthesis Example 3 except that the anionic functional group monomer used for the synthesis of the anionic resin was changed to 14 g (5 mol %) of 5-sulfoisophthalic acid and 19 g (10 mol %) of trimellitic anhydride, the polycarboxylic acid monomer used for the synthesis of the anionic resin was changed to 58 g (35 mol %) of terephthalic acid, and the diol used for the synthesis of the anionic resin was changed to 23 g (25 mol %) of 1,4-butanediol and 35 g (25 mol %) of 1,4-benzenedimethanol.

The acid value of the obtained anionic resin was 60 mgKOH/g, and the number average molecular weight of the obtained anionic resin was 8,000.

### <4> Preparation of Dispersant-Containing Liquid

### Example A1

25.0 g of the anionic resin synthesized in Synthesis Example 1, 7.0 g of 2-butylaminoethanol as linear monoalkylamine, and 68.0 g of pure water were added to a flask and stirred at 70° C. for 60 minutes, thereby obtaining a uniform dispersant-containing liquid.

### Examples A2 to A8

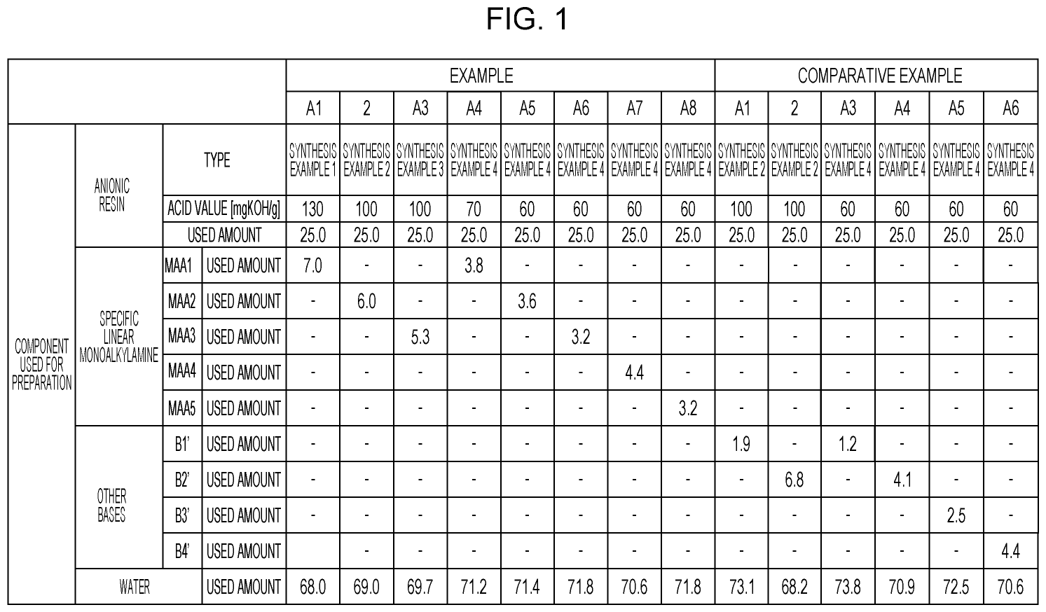

Dispersant-containing liquids were prepared in the same manner as in Example A1 except that the kinds and the used amounts of the components used for the preparation of the dispersant-containing liquids were changed as shown in FIG. 1.

### Comparative Examples A1 to A6

Dispersant-containing liquids were prepared in the same manner as in Example A1 except that the kinds and the used amounts of the components used for the preparation of the dispersant-containing liquids were changed as shown in FIG. 1.

The conditions for the dispersant-containing liquids according to Examples A1 to A8 and Comparative Examples A1 to A6 are collectively shown in FIG. 1. Further, the numerical values in the columns of “used amount” of “component used for preparation” in FIG. 1 denote the used amounts of the components in units of parts by mass. Further, in FIG. 1, “MAA1” denotes 2-butylaminoethanol, “MAA2” denotes 3-butoxypropylamine, “MAA3” denotes 1-amino-2-hexanol, “MAA4” denotes 2-(2-butoxyethoxy)ethaneamine, “MAA5” denotes 2-amino-1-hexanol, “B1′” denotes sodium hydroxide, “B2′” denotes trimethanolamine, “B3′” denotes 2-ethylaminoethanol, and “B4′” denotes 2-heptylaminoethanol.

### <5> Preparation of Stock Solution of Ink Jet Ink as Aqueous Coloring Material Dispersion Liquid

### Example B1

30 g of the dispersant-containing liquid prepared in Example A1 was mixed with 55 g of pure water, 15 g of C.I. Pigment Blue 15:3 as an organic coloring material was added to the mixture, the mixture was dispersed in a bead mill for 0.5 hours using zirconia balls having a diameter of 0.5 mm as a medium, the beads were separated, and the mixture was filtered through a filter having a pore size of 8μ m, thereby obtaining a stock solution of an ink jet ink as an aqueous coloring material dispersion liquid. The average particle diameter of the organic coloring material contained in the stock solution of the ink jet ink obtained as described above was 130 nm.

### Examples B2 to B8

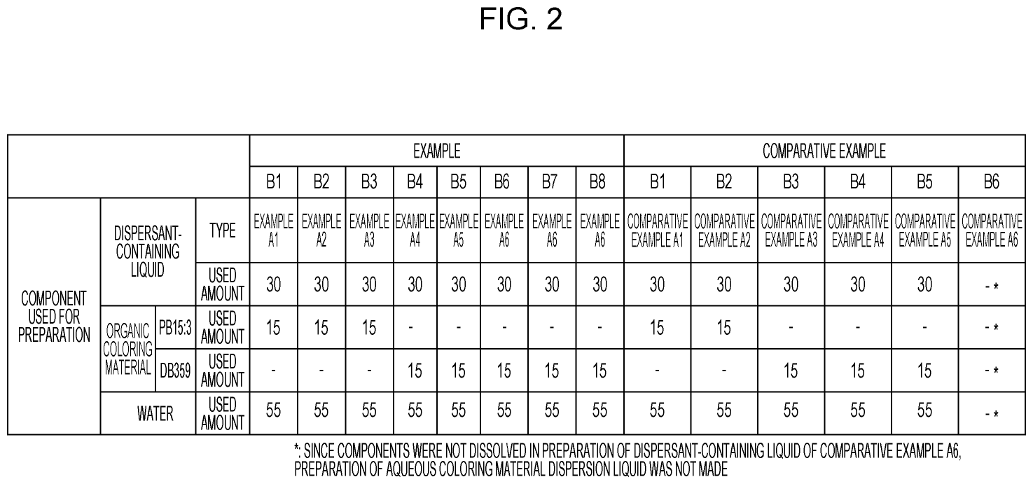

Stock solutions of ink jet inks as aqueous coloring material dispersion liquids were prepared in the same manner as in Example B1 except that the kinds of the dispersant-containing liquids and the kinds of the coloring materials used for preparation of the stock solutions of ink jet inks were changed as shown in FIG. 2.

### Comparative Examples B1 to B6

Stock solutions of ink jet inks as aqueous coloring material dispersion liquids were prepared in the same manner as in Example B1 except that the kinds of the dispersant-containing liquids and the kinds of the coloring materials used for preparation of the stock solutions of ink jet inks were changed as shown in FIG. 2 and the dispersion treatment using a bead mill was performed until the average particle diameter of the organic coloring material reached 130 nm.

The conditions of the stock solutions of ink jet inks according to Examples B1 to B8 and Comparative Examples B1 to B6 are collectively shown in FIG. 2. Further, the numerical values in the columns of “used amount” of “component used for preparation” in FIG. 2 denote the used amounts of the components in units of parts by mass. Further, in FIG. 2, “PB15:3” denotes C.I. Pigment Blue 15:3, and “DB359” denotes C.I. Disperse Blue 359. Further, in the stock solutions of ink jet inks in the examples described above, the average particle diameters of the organic coloring materials contained in the stock solutions of the ink jet inks were all in a range of 100 nm or greater and 130 nm or less.

Further, since the components were not dissolved in the preparation of the dispersant-containing liquid of Comparative Example A6, preparation of the aqueous coloring material dispersion liquid was not made in Comparative Example B6.

### <6> Preparation of Ink Jet Ink as Aqueous Coloring Material Dispersion Liquid

### Example C1

25 g of the stock solution of an ink jet ink which had been prepared in Example B1, 20 g of glycerin as a moisturizer, 5 g of trimethylolpropane as a moisturizer, 0.4 g of SILFACE SAG002 (manufactured by Nissin Chemical Co., Ltd.) as a surface tension adjuster, 0.2 g of OLFINE E1004 (manufactured by Nissin Chemical Co., Ltd.) as a surface tension adjuster, 4 g of triethylene glycol monobutyl ether as a surface tension adjuster, 0.2 g of triethanolamine as a pH adjuster, and 45.2 g of pure water were mixed with each other, and the mixture was stirred at room temperature for 30 minutes and filtered by a microfiltration filter having a pore size of 3μ m, thereby obtaining an ink jet ink serving as an aqueous coloring material dispersion liquid.

### Examples C2 to C8

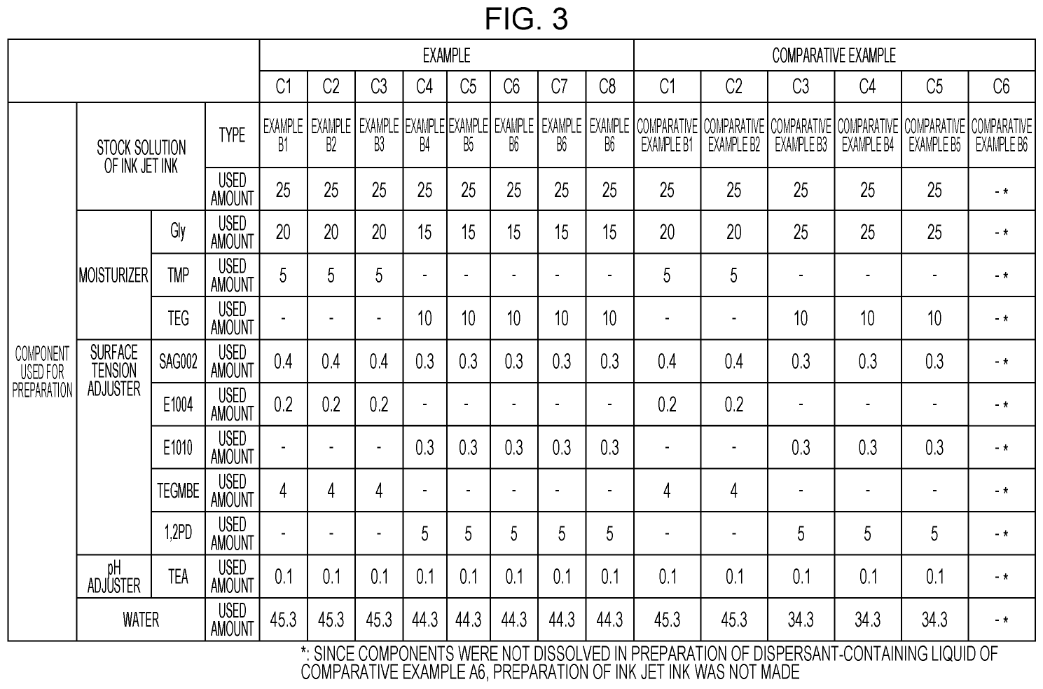

Ink jet inks as aqueous coloring material dispersion liquids were prepared in the same manner as in Example C1 except that the kinds of the stock solutions of ink jet inks and the kinds and the used amounts of the added components used for preparation of ink jet inks were changed as shown in FIG. 3.

### Comparative Examples C1 to C6

Ink jet inks as aqueous coloring material dispersion liquids were prepared in the same manner as in Example C1 except that the kinds of the stock solutions of ink jet inks and the kinds and the used amounts of the added components used for preparation of ink jet inks were changed as shown in FIG. 3.

The conditions of the ink jet inks according to Examples C1 to C8 and Comparative Examples C1 to C6 are collectively shown in FIG. 3. Further, the numerical values in the columns of “used amount” of “component used for preparation” in FIG. 3 denote the used amounts of the components in units of parts by mass. Further, in FIG. 3, “Gly” denotes glycerin, “TMP” denotes trimethylolpropane, “TEG” denotes triethylene glycol, “SAG002” denotes SILFACE SAG002 (manufactured by Nissin Chemical Co., Ltd.), “E1004” denotes OLFINE E1004 (manufactured by Nissin Chemical Co., Ltd.), “E1010” denotes OLFINE E1010 (manufactured by Nissin Chemical Co., Ltd.), “TEGMBE” denotes triethylene glycol monobutyl ether, “1,2PD” denotes 1,2-pentanediol, and “TEA” denotes triethanolamine. Further, in the ink jet inks of the examples described above, the average particle diameters of the organic coloring materials contained in the ink jet inks were all in a range of 100 nm or greater and 130 nm or less. The ink jet inks of the above-described examples all had a viscosity of 2.0 mPa·s or greater and 9.0 mPa·s or less. Further, the viscosity was measured by increasing the shear rate from 10 [s⁻¹] to 1,000 [s⁻¹] at 20° C. using a viscoelasticity tester such as MCR-300 (manufactured by Physica) and reading the viscosity when the shear rate reached 200. In addition, the ink jet inks of the above-described examples all had a surface tension of 23 mN/m or greater and 30 mN/m or less. The surface tension was measured at 20° C. by a Wilhelmy method using a surface tension meter (CBVP-7, manufactured by Kyowa Interface Science Co., Ltd.).

Further, since the components were not dissolved in the preparation of the dispersant-containing liquid of Comparative Example A6, preparation of the ink jet ink was not made in Comparative Example C6.

### <7> Evaluation

### <7-1> Evaluation of Storage Stability Based on Stability of Viscosity

The ink jet inks of Examples C1 to C8 and Comparative Examples C1 to C6 were respectively placed in sample containers and allowed to stand in an environment of 70° C. for 1 week, the viscosities thereof at 20° C. were measured and compared with the viscosities of the corresponding ink jet inks at 20° C. immediately after the production, and the storage stability was evaluated according to the following evaluation criteria. It can be said that the storage stability is excellent as the rate of fluctuation in the viscosity decreases.
A: The rate of fluctuation in the viscosity from immediately after production was less than 10%.
B: The rate of fluctuation in the viscosity from immediately after production was 10% or greater and less than 20%.
C: The rate of fluctuation in the viscosity from immediately after production was 20% or greater.
D: Aggregation and gelation occurred, and thus the measurement of the viscosity was not made.

### <7-2> Evaluation of Storage Stability Based on Stability of Particle Diameter

The ink jet inks of Examples C1 to C8 and Comparative Examples C1 to C6 were respectively placed in sample containers and allowed to stand in an environment of 60° C. for 1 week, the average particle diameters of the organic coloring materials in an environment of 20° C. were determined and compared with the average particle diameters of the organic coloring materials contained in the corresponding ink jet inks immediately after the production, and the storage stability was evaluated according to the following evaluation criteria. It can be said that the storage stability increases and the negative impact on the storage stability decreases as the rate of fluctuation in the particle diameter of the organic coloring material decreases. Further, the average particle diameter was measured using MICROTRAC UPA (manufactured by Nikkiso Co., Ltd.).
A: The rate of fluctuation in the average particle diameter of the organic coloring material from immediately after production was less than 15%.
B: The rate of fluctuation in the average particle diameter of the organic coloring material from immediately after production was 15% or greater and less than 30%.
C: The rate of fluctuation in the average particle diameter of the organic coloring material from immediately after production was 30% or greater.
D: Aggregation and gelation occurred, and thus the measurement of the particle diameter of the dispersoid was not made.

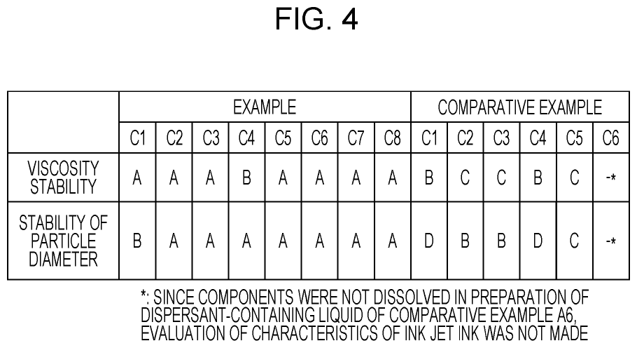

The above-described evaluation results are collectively shown in FIG. 4.

As is apparent in FIG. 4, excellent results were obtained in the present disclosure. Particularly, in the production of the aqueous coloring material dispersion liquid of the present disclosure, the organic coloring material was suitably disintegrated and dispersed even when the dispersion treatment was performed for a short time of 0.5 hours, and the obtained aqueous coloring material dispersion liquid had excellent dispersion stability of the organic coloring material and excellent storage stability.

On the contrary, satisfactory results were not obtained in each comparative example.

The reason for this is considered as follows. That is, in Comparative Examples C1 and C2 in which sodium hydroxide and triethanolamine were used in place of the linear monoalkylamine even though the ink contained the same anionic resin as in Example C1, it was considered that since an increase in wettability with respect to the organic coloring material of the resin was not made during the dispersion of the organic coloring material, the stress on the organic coloring material during the dispersion was higher than that of the present disclosure, and as a result, the dispersion stability of the organic coloring material was degraded. Further, in Comparative Examples C3 and C4 in which sodium hydroxide and triethanolamine were used in place of the linear monoalkylamine even though the ink contained the same anionic resin as in Example C4, it was considered that the dispersion stability of the organic coloring material was degraded due to the excessive stress applied on the organic coloring material during the dispersion of the organic coloring material similarly to Comparative Examples C1 and C2. Further, in Comparative Example C5, even though the linear monoalkylamine was used, since the linear monoalkylamine did not correspond to any of the compounds represented by Formula (1) to (5), the wettability with respect to the organic coloring material of the anionic resin was insufficient, the time required for disintegration and dispersion of the organic coloring material to a target particle diameter was increased, and thus overdispersion occurred. Therefore, it was considered that the dispersion stability of the organic coloring material was degraded. Further, since the components were not dissolved in the preparation of the dispersant-containing liquid of Comparative Example A6, the preparation of the ink jet ink was not made in Comparative Example C6, and thus the evaluation of the characteristics was also not made.

Further, the dispersant-containing liquids, the stock solutions of ink jet inks as aqueous coloring material dispersion liquids, and the ink jet inks were prepared in the same manners as in the examples except that a compound in which a in Formula (1) represents 2, 4, or 5 and b in Formula (1) represents 3, a compound in which a in Formula (2) represents 2, 4, or 5 and c represents 1 or 2, a compound in which a in Formula (3) represents 2, 4, or 5, a compound in which a in Formula (4) represents 2, 4, or 5, and a compound in which a in Formula (5) represents 2, 4, or 5 were used as the linear monoalkylamine, and the evaluations were performed in the same manners as described above. As a result, excellent results were obtained similarly to the examples described above.

Further, the stock solutions of ink jet inks as aqueous coloring material dispersion liquids and the ink jet inks were prepared in the same manners as in the examples described above except that an oil-soluble dye C.I. Solvent Yellow 160:1 was used as the organic coloring material, and the evaluations were performed in the same manners as described above. As a result, excellent results were obtained similarly to the examples described above.

What is claimed is:

1. A dispersant-containing liquid comprising:
an anionic resin containing a carboxyl group and/or a sulfo group and having an acid value of 50 mgKOH/g or greater and 300 mgKOH/g or less as an anionic functional group;
linear monoalkylamine; and
water,
wherein the linear monoalkylamine is at least one selected from the group consisting of a compound represented by Formula (1), a compound represented by Formula (2), a compound represented by Formula (3), a compound represented by Formula (4), and a compound represented by Formula (5),
CH₃(CH₂)ₐ—NH—(CH₂)_{b}—OH (1)
in Formula (1), a represents an integer of 2 or greater and 5 or less, and b represents 2 or 3,
CH₃(CH₂)ₐ—O—(CH₂)_{c}—NH₂ (2)
in Formula (2), a represents an integer of 2 or greater and 5 or less, and c represents an integer of 1 or greater and 3 or less,
CH₃(CH₂)ₐ—(O—CH₂CH₂)₂—NH₂ (3)
in Formula (3), a represents an integer of 2 or greater and 5 or less,
CH₃(CH₂)ₐ—CH(OH)—CH₂—NH₂ (4)
in Formula (4), a represents an integer of 2 or greater and 5 or less,
CH₃(CH₂)ₐ—CH(NH₂)—CH₂—OH (5)
in Formula (5), a represents an integer of 2 or greater and 5 or less.

2. The dispersant-containing liquid according to claim 1,
wherein the anionic resin is a copolymer that contains an addition polymerizable monomer containing the anionic functional group as a constituent monomer.

3. The dispersant-containing liquid according to claim 1,
wherein the anionic resin is a copolymer that contains a condensation polymerizable monomer containing the anionic functional group as a constituent monomer.

4. An aqueous coloring material dispersion liquid comprising:
at least one organic coloring material selected from the group consisting of a pigment, a disperse dye, and an oil-soluble dye;
an anionic resin containing a carboxyl group and/or a sulfo group and having an acid value of 50 mgKOH/g or greater and 300 mgKOH/g or less as an anionic functional group;
linear monoalkylamine; and
water,
wherein the linear monoalkylamine is at least one selected from the group consisting of a compound represented by Formula (1), a compound represented by Formula (2), a compound represented by Formula (3), a compound represented by Formula (4), and a compound represented by Formula (5),
CH₃(CH₂)ₐ—NH—(CH₂)_{b}—OH (1)
in Formula (1), a represents an integer of 2 or greater and 5 or less, and b represents 2 or 3,
CH₃(CH₂)ₐ—O—(CH₂)_{c}—NH₂ (2)
in Formula (2), a represents an integer of 2 or greater and 5 or less, and c represents an integer of 1 or greater and 3 or less,
CH₃(CH₂)ₐ—(O—CH₂CH₂)₂—NH₂ (3)
in Formula (3), a represents an integer of 2 or greater and 5 or less,
CH₃(CH₂)ₐ—CH(OH)—CH₂—NH₂ (4)
in Formula (4), a represents an integer of 2 or greater and 5 or less,
CH₃(CH₂)ₐ—CH(NH₂)—CH₂—OH (5)
in Formula (5), a represents an integer of 2 or greater and 5 or less.

5. The aqueous coloring material dispersion liquid according to claim 4,
wherein the aqueous coloring material dispersion liquid is an ink jet ink.

6. The aqueous coloring material dispersion liquid according to claim 5,
wherein the ink jet ink further contains a moisturizer and a surface tension adjuster.

7. The aqueous coloring material dispersion liquid according to claim 4,
wherein the anionic resin is a copolymer that contains an addition polymerizable monomer containing the anionic functional group as a constituent monomer.

8. The aqueous coloring material dispersion liquid according to claim 4,
wherein the anionic resin is a copolymer that contains a condensation polymerizable monomer containing the anionic functional group as a constituent monomer.
